(19) United States
(12) Patent Application Publication
(10) Pub. No.: US 2025/0292451 A1
(43) Pub. Date: Sep. 18, 2025

(54) IMAGE GENERATION METHOD, APPARATUS, AND DEVICE, AND STORAGE MEDIUM

(71) Applicant: BEIJING SOGOU TECHNOLOGY DEVELOPMENT CO., LTD., Beijing (CN)

(72) Inventors: Quan QING, Beijing (CN); Zhongang QI, Beijing (CN); Keyu ZHAI, Beijing (CN); Xintao WANG, Beijing (CN); Wenkai ZHENG, Beijing (CN); Yanze WU, Beijing (CN)

(21) Appl. No.: 19/222,686

(22) Filed: May 29, 2025

Related U.S. Application Data
(63) Continuation of application No. PCT/CN2023/132219, filed on Nov. 17, 2023.

(30) Foreign Application Priority Data
Apr. 28, 2023 (CN) 202310486981.4

(51) Int. Cl. G06T 11/00; G06V 10/44

(52) U.S. Cl. CPC G06T 11/00; G06V 10/44

(57) ABSTRACT

This application provides an image generation method, apparatus, and device, and a storage medium, and relates to the field of computer technologies. The method includes: obtaining target information for performing image generation, the target information including a text set; transmitting an image generation request to a server in response to an image generation operation on the target information, the image generation request carrying the target information; receiving M groups of images transmitted by the server, each group of the M groups of images including two images that have a pairwise relationship in terms of preset content, the M groups of images being generated by the server based on the target information and a pre-trained image generation model, and M being a positive integer; and displaying the M groups of images.

### CROSS-REFERENCE TO RELATED APPLICATIONS

This application is a continuation of International Application No. PCT/CN2023/132219, filed on Nov. 17, 2023, which claims priority to Chinese Patent Application No. 2023104869814, entitled “IMAGE GENERATION METHOD, APPARATUS, AND DEVICE, AND STORAGE MEDIUM” and filed with the China National Intellectual Property Administration on Apr. 28, 2023, the entire contents of both of which are incorporated herein by reference.

### FIELD OF THE TECHNOLOGY

The embodiments of this application relate to the field of computer technologies, and in particular, to an image generation method, apparatus, and device, and a storage medium.

### BACKGROUND OF THE DISCLOSURE

With the rapid development of computer technologies and the diversification of social products, a user may upload one or more avatars representing an image of the user through a social platform. The user may upload a real-life image, or search for a network image through image search and upload the network image.

An avatar uploaded to a social product has certain privacy and personalized avatar setting requirements. Therefore, currently, a personalized avatar may be generated based on a user requirement by using a painting software program.

However, the existing painting software program can only generate a single image, but cannot generate images having pairwise relationships such as couple images and bestie images, and a need for generating personalized avatars cannot be met. Images having a pairwise relationship are two images that are perceived as images having a pairwise relationship in terms of image content and image styles.

### SUMMARY

In accordance with the disclosure, there is provided an image generation method including obtaining target information including a text set, transmitting an image generation request carrying the target information to a server in response to an image generation operation on the target information, and receiving M groups of images transmitted by the server. Each of the M groups of images includes two images that have a pairwise relationship in terms of preset content. The M groups of images are generated by the server based on the target information and a pre-trained image generation model. M is a positive integer. The method further includes displaying the M groups of images.

Also in accordance with the disclosure, there is provided an image generation device including a processor, and a memory storing a computer program that, when executed by the processor, causes the device to obtain target information including a text set, transmit an image generation request carrying the target information to a server in response to an image generation operation on the target information, and receive M groups of images transmitted by the server. Each of the M groups of images includes two images that have a pairwise relationship in terms of preset content. The M groups of images are generated by the server based on the target information and a pre-trained image generation model. M is a positive integer. The computer program further causes the device to display the M groups of images.

Also in accordance with the disclosure, there is provided an image generation method including receiving an image generation request transmitted by a terminal device and carrying target information including a text set, and generating M groups of images based on the target information and a pre-trained image generation model. Each of the M groups of images includes two images that have a pairwise relationship in terms of preset content. The method further includes transmitting the M groups of images to the terminal device.

### BRIEF DESCRIPTION OF THE DRAWINGS

To describe the technical solutions in the embodiments of the present disclosure more clearly, the following briefly describes the accompanying drawings needed for describing the embodiments. Apparently, the accompanying drawings in the following descriptions show merely some embodiments of the present disclosure, and a person of ordinary skill in the art may still derive other drawings from these accompanying drawings without creative efforts.

FIG. 1 is a schematic diagram showing a system architecture of an image generation method according to an embodiment of this application.

FIG. 2 is a schematic diagram showing an application scenario of an image generation method according to an embodiment of this application.

FIG. 3 is a schematic diagram showing an application scenario of an image generation method according to an embodiment of this application.

FIG. 4 is a flowchart of an image generation method according to an embodiment of this application.

FIG. 5 is a schematic diagram showing an image generation page according to an

embodiment of this application.

FIG. 6 is a schematic diagram showing a search result page according to an embodiment of this application.

FIG. 7 is a schematic diagram showing a process of displaying an image

generation page according to an embodiment of this application.

FIG. 8 is a schematic diagram showing a process of displaying an image

generation page according to an embodiment of this application.

FIG. 9 is a schematic diagram showing an image generation page according to an embodiment of this application.

FIG. 10 is a schematic diagram showing an image generation page according to an embodiment of this application.

FIG. 11 is a schematic diagram showing an image generation page according to an embodiment of this application.

FIG. 12 is a flowchart of an image generation method according to an embodiment of this application.

FIG. 13 is an interaction flowchart of an image generation method according to an embodiment of this application.

FIG. 14 is a schematic structural diagram of an image generation apparatus according to an embodiment of this application.

FIG. 15 is a schematic structural diagram of an image generation apparatus according to an embodiment of this application.

FIG. 16 is a schematic block diagram of an image generation device according to an embodiment of this application.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

In this specification, the claims, and the accompanying drawings of the present disclosure, the terms “first,” “second,” and so on are intended to distinguish similar objects but do not necessarily indicate a specific order or sequence. The data termed in such a way are interchangeable in appropriate circumstances, so that the embodiments of the present disclosure described herein can be implemented in orders other than the order illustrated or described herein. Moreover, the terms “comprise,” “include,” and any other variants thereof mean to cover the non-exclusive inclusion. For example, a process, method, system, product, or server that includes a list of operations or units is not necessarily limited to those operations or units that are clearly listed, but may include other operations or units not expressly listed or inherent to such a process, method, product, or device.

Before the technical solutions of this application are described, related knowledge of this application is described below.

1. Artificial Intelligence (AI) is a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making. The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing (NLP) technology, and machine learning (ML)/deep learning. The embodiments of this application specifically relate to the CV technology, the NLP technology, and ML that belong to the AI technologies.

2. CV is a science that studies how to enable a machine to “see,” and to be specific, to implement machine vision such as recognition, measurement, and the like for a target by using a camera and a computer in replacement of human eyes, and further perform graphic processing, so that the computer processes the target into an image more suitable for human eyes to observe, or more suitable to be transmitted to an instrument for detection. As a scientific subject, CV studies related theories and technologies and attempts to establish an AI system that can obtain information from images or multidimensional data. The CV technologies generally include technologies such as image processing, image recognition, image semantic understanding, image retrieval, optical character recognition (OCR), video processing, video semantic understanding, video content recognition, three-dimensional object reconstruction, a 3D technology, virtual reality, augmented reality, and map construction. The embodiments of this application specifically relate to image processing belong to CV. M groups of images are generated based on an inputted text set and a pre-trained image generation model, or M groups of images are generated based on an inputted text set, an uploaded target image, and a pre-trained image generation model. Each group of the M groups of images includes two images that have a pairwise relationship in terms of preset content. A requirement for generating personalized avatars having pairwise relationships can be met.

3. NLP is an important direction in the fields of computer science and AI. Studies in this field relate to natural languages, that is, languages used by people in daily life, and NLP is closely related to linguistic studies. NLP technologies usually include text processing, semantic understanding, machine translation, robot question answering, knowledge graphs and other technologies.

4. ML is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving performance of the computer. This application further relates to ML in the field of AI. For example, an ML model is trained by using an ML technology, so that the trained ML model can generate personalized images based on an inputted text, and specifically, can generate images having a pairwise relationship.

5. Images having a pairwise relationship are two images that are perceived as images having a pairwise relationship in terms of image content and image styles. The image content refers to elements included in the image, for example, a person, an animal, and a scenery in the image. The image styles refer to different art styles, for example, a cartoon style, a classical Chinese style, and a punk style. In this disclosure, images having a pairwise relationship are also referred to as “pairwise images.”

In the related art, only a single image can be generated, and for images having pairwise relationships such as couple images and bestie images, a requirement for generating personalized avatars cannot be met. To resolve this technical problem, in this application, a terminal device obtains target information for performing image generation, the target information including a text set. In response to an image generation operation on the target information, the terminal device transmits an image generation request to a server, the image generation request carrying the target information. The server generates M groups of images based on the target information and a pre-trained image generation model, each group of images including two images that have a pairwise relationship in terms of preset content. The terminal device receives and displays the M groups of images transmitted by the server, to generate images having pairwise relationships based on the inputted text set, thereby satisfying a requirement for generating personalized avatars having pairwise relationships.

The following describes the technical solutions of this application in detail.

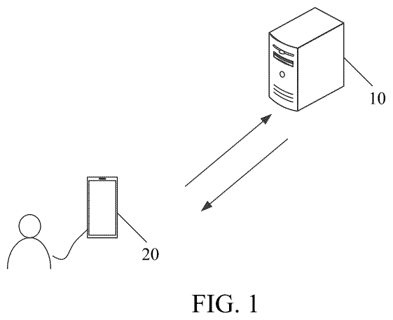

For example, FIG. 1 is a schematic diagram showing a system architecture of an image generation method according to an embodiment of this application. As shown in FIG. 1, the system architecture may include a server 10 and a terminal device 20. There may be one or more terminal devices 20, and a quantity of terminal devices is not limited herein. As shown in FIG. 1, the terminal device 20 may establish a network connection with the server 10, to exchange data with the server 10 through the network connection.

The terminal device may include an intelligent terminal having an image generation function, for example, a smartphone, a tablet computer, a notebook computer, a desktop computer, a wearable device, a smart household, a head-mounted device, an in-vehicle terminal, or an intelligent voice interaction device. A target application (namely, an application client) may be installed on the terminal device 20 shown in FIG. 1. When the application client runs in the terminal device, data exchange may be performed between the application client and the server 10 shown in FIG. 1.

The server 10 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

For example, an application client having an image generation function may be integrated in the terminal device 20. The application client may include a client having image loading and displaying functions, for example, a social client (for example, an instant messaging client), a multimedia client (for example, a video client), an entertainment client (for example, a game client), or an education client.

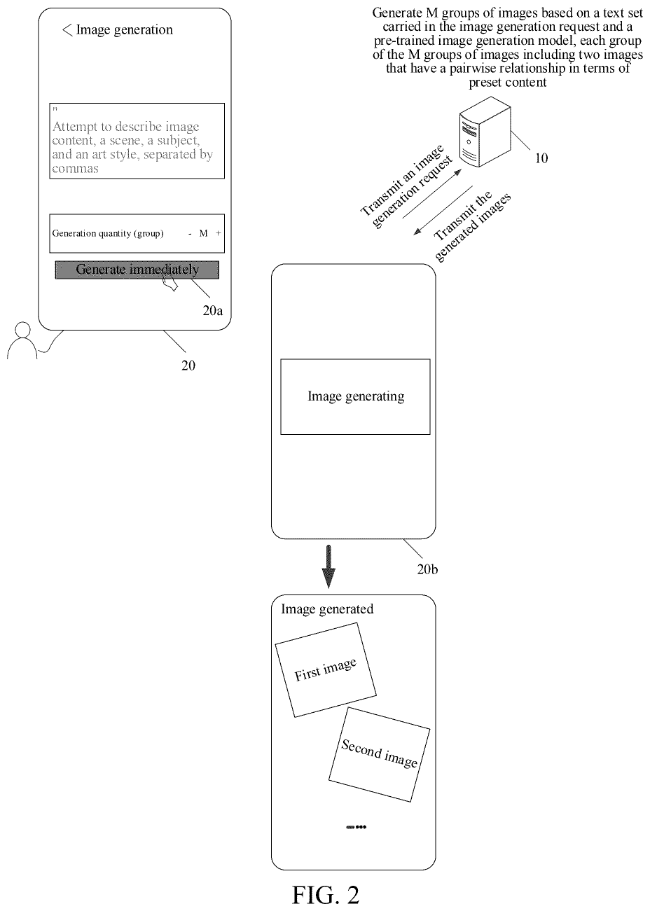

For ease of understanding, further, referring to FIG. 2, FIG. 2 is a schematic diagram showing an application scenario of an image generation method according to an embodiment of this application. A server shown in FIG. 2 may be the foregoing server 10, and a terminal device shown in FIG. 2 may be the terminal device displayed in FIG. 1.

As shown in FIG. 2, in an embodiment, the terminal device 20 may be a terminal device used by a target object (for example, a user A). The target object may select or input, in the terminal device, a text set that the target object intends to use to generate images. The text set includes one or more texts. A quantity of texts selected or inputted by the target object is not limited herein. For example, the target object may input text information into a text input box provided by the terminal device, as the text set. Specifically, the target object may perform a trigger operation on a text input control provided on an image generation page, to input the text set into the terminal device. The image generation page is a display page of the terminal device held by the target object. As shown in FIG. 2, the terminal device may display, on the image generation page, the text set inputted or selected by the target object. As shown in FIG. 2, a generation control 20a is displayed on the image generation page. After the target object selects the text set, a trigger operation on the generation control 20a displayed on the image generation page may be performed. Further, the terminal device may perform page jump, to jump the image generation page to a first display page 20b. The first display page 20b displays “Image generating,” to prompt the user that images are currently being generated based on the text set. After M group of images having pairwise relationships are generated, the M group of images having pairwise relationships may be displayed. Each group of images includes two images that have a pairwise relationship in terms of preset content, for example, couple images or bestie images. As shown in FIG. 2, the terminal device first displays one group of images, and the group of images includes a first image and a second image.

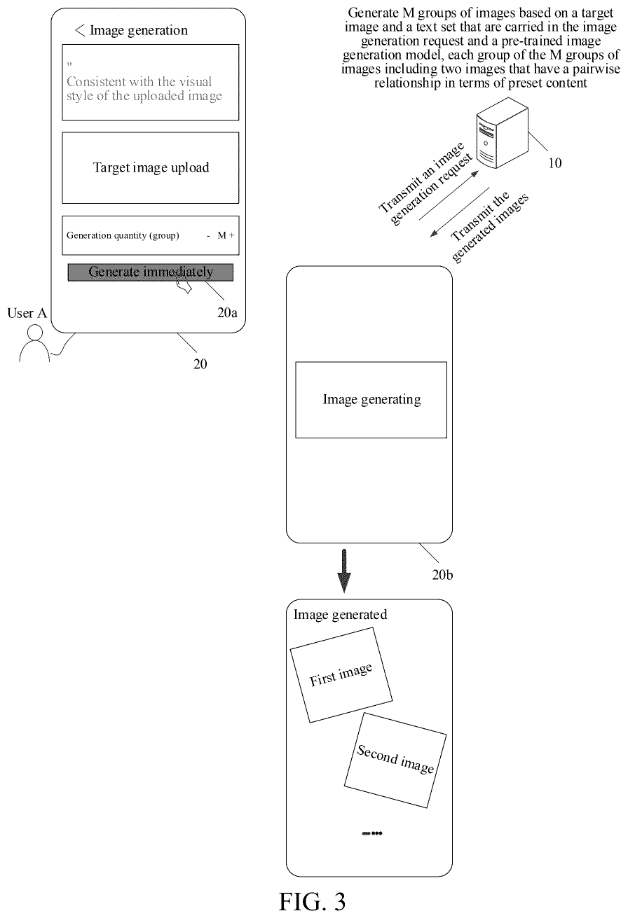

FIG. 3 is a schematic diagram showing an application scenario of an image generation method according to an embodiment of this application. A server shown in FIG. 3 may be the foregoing server 10, and a terminal device shown in FIG. 3 may be the terminal device displayed in FIG. 1.

In an embodiment, as shown in FIG. 3, a target object may select a target image and a text set according to a requirement of the target object, perform a trigger operation on an image upload control provided on an image generation page, and perform a trigger operation on a text input control provided on the image generation page, to input the target image and the text set into the terminal device. The image generation page is a display page of the terminal device held by the target object. As shown in FIG. 3, the terminal device may display, on the image generation page, the target image and the text set uploaded by the target object. The image generation page displays a generation control 20a. After the target object selects the target image and the text set, a trigger operation on the generation control 20a displayed on the image generation page may be implemented. Further, the terminal device may perform page jump, to jump the image generation page 20a to a first display page 20b. The first display page 20b displays “Image generating,” to prompt the user that images are currently being generated based on the target image and the text set. After M group of images having pairwise relationships are generated, the M group of images having pairwise relationships may be displayed. Each group of images includes two images that have a pairwise relationship in terms of preset content, for example, couple images or bestie images. As shown in FIG. 3, the terminal device first displays one group of images, and the group of images includes a first image and a second image. The first image may be the target image, and the second image is a generated image having a pairwise relationship with the target image.

The embodiments of this application may be applied to various scenarios, including but not limited to, scenarios such as cloud technologies, artificial intelligence, and intelligent transportation.

The following describes the technical solutions of this application in detail with reference to the accompanying drawings.

The following describes the technical solutions of this application and how to resolve the foregoing technical problems according to the technical solutions of this application in detail by using specific embodiments. The following several specific embodiments may be combined with each other, and a same or similar concept or process may not be described repeatedly in some embodiments. The following describes the embodiments of this application with reference to the accompanying drawings.

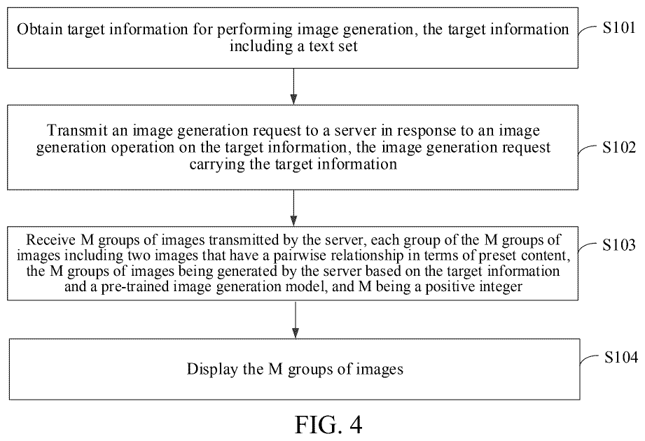

FIG. 4 is a flowchart of an image generation method according to an embodiment of this application. The image generation method may be performed by an image generation apparatus, and the image generation apparatus may be implemented in a software and/or hardware manner. The image generation apparatus may be a terminal device or a chip or a circuit of a terminal device, and may be specifically a client having an image generation function integrated therein. As shown in FIG. 4, the image generation method according to this embodiment may include the following operations:

S101: The terminal device obtains target information for performing image generation, the target information including a text set.

S102: The terminal device transmits an image generation request to a server in response to an image generation operation on the target information, the image generation request carrying the target information.

S103: The terminal device receives M groups of images transmitted by the server, each group of the M groups of images including two images that have a pairwise relationship in terms of preset content, the M groups of images being generated by the server based on the target information and a pre-trained image generation model, and M being a positive integer. The preset content is picture content displayed by each image.

S104: The terminal device displays the M groups of images.

Specifically, the terminal device obtains the target information for performing image generation. The target information is information inputted by a target object into the terminal device to obtain the images having pairwise relationships. The target information includes the text set. The text set may include one or more texts. The text set may be text information inputted by the target object into a text input box provided by the terminal device, a recommended tag selected by the target object from recommended tags provided by the terminal device, or a combination of the text information inputted by the target object and the selected recommended tag.

In some embodiments, the terminal device may specifically obtain the target information for performing image generation in the following three manners.

Manner 1: The text set inputted by the target object into a text box of an image generation page is received.

Manner 2: A first text inputted by the target object into a text box of an image generation page is received, and in response to a selection operation of the target object on a recommended tag displayed on the image generation page, a second text corresponding to the recommended tag selected by the target object is written into the text box. The text set is obtained based on the first text and the second text corresponding to the recommended tag selected by the target object. The first text and the second text may include one or more texts. The first text is a text inputted by the target object into the text box of the image generation page. The second text is a text corresponding to the recommended tag selected by the target object for recommended tags displayed on the image generation page. The first text and the second text form the text set.

Manner 3: In response to a selection operation of the target object on a recommended tag displayed on an image generation page, a text corresponding to the recommended tag selected by the target object is written into a text box; and the text set is obtained based on the text corresponding to the recommended tag selected by the target object.

Further, in an implementation, the target information further includes M, M is configured for indicating an image generation quantity (i.e., the target information further includes a number M indicating an image generation quantity), and one or more groups of images may be generated at a time. Based on any one of the foregoing three manners, the method according to this embodiment may further include:

The terminal device combines the text set and M to form the target information (i.e., combines the text set and the number M to form the target information).

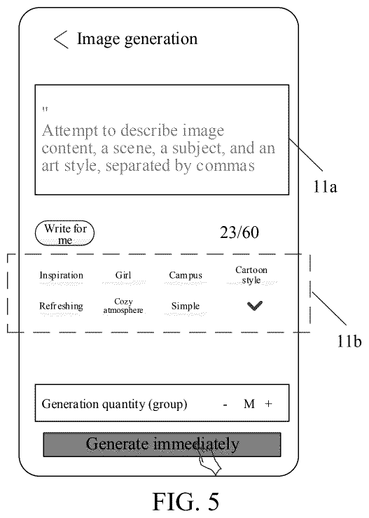

FIG. 5 is a schematic diagram showing an image generation page according to an embodiment of this application. In an embodiment, as shown in FIG. 5, the image generation page may include a text box 11a and a setting option of a generation quantity. In some embodiments, the image generation page may include a text box 11a, a recommended tag 11b, and a setting option of a generation quantity. In Manner 1 above, the target object may input the text set, for example, “attempt to describe image content, a scene, a subject, and an art style of a to-be-generated image, separated by commas,” into the text box of the image generation page. In Manner 2 above, the target object may input the first text, for example, “attempt to describe image content, a scene, a subject, and an art style of a to-be-generated image, separated by commas,” into the text box of the image generation page. Alternatively, the target object may select a recommended tag from tags displayed in the recommended tag 11b. Correspondingly, the terminal device writes, in response to a selection operation of the target object on the recommended tag displayed on the image generation page, a text corresponding to the recommended tag selected by the target object into the text box, and obtain the text set based on the first text and the text corresponding to the recommended tag selected by the target object. In Manner 3 above, the target object may select a recommended tag from tags displayed in the recommended tag 11b. Correspondingly, the terminal device writes, in response to a selection operation of the target object on the recommended tag displayed on the image generation page, a text corresponding to the recommended tag selected by the target object into the text box, and obtain the text set based on the text corresponding to the recommended tag selected by the target object. In some embodiments, M may be 1, or may be a positive integer greater than 1. When M is 1, M may be a default value and does not need to be set by the user. When the user sets M, the terminal device combines the text set and M to form the target information. In some embodiments, the target object may further perform corresponding operations such as adding, modifying, deleting, and rewriting text information on the text filled in the text box.

The following describes an opening manner of the image generation page in detail. Before S101, the image generation page needs to be displayed in response to an operation performed by the target object. This embodiment shows the following two optional implementations.

In some embodiments, in an implementation, before S101, the method according to this embodiment may further include:

S105: The terminal device displays a search result page in response to an operation of inputting a preset keyword into a target browser input box by the target object, where the search result page includes a first view and a second view, the first view includes at least one group of images generated, each group of images includes two images that have a pairwise relationship in terms of the preset content, and the second view includes an entry for entering an image generation page.

S106: The terminal device displays the image generation page in response to an image generation operation triggered by the target object in the first view.

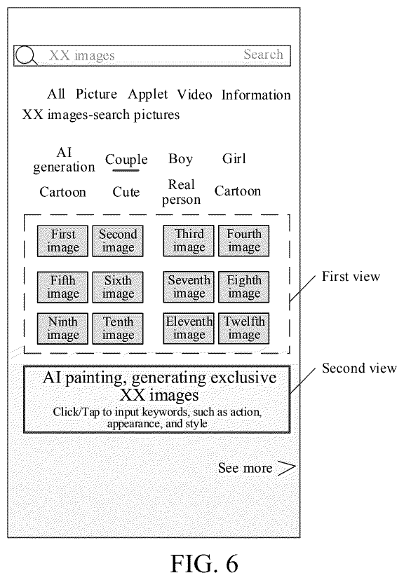

FIG. 6 is a schematic diagram showing a search result page according to an embodiment of this application. As shown in FIG. 6, the target object inputs a preset keyword, for example, “XX images” or “XX avatars,” into a target browser input box. The XX images may be images having a pairwise relationship such as couple images or bestie images. After Search is clicked/tapped, the terminal device displays the search result page shown in FIG. 6 in response to the operation of inputting the preset keyword into the target browser input box by the target object. The search result page may include a first view and a second view. The first view includes at least one group of XX images generated. Each group of images includes two images that have a pairwise relationship in terms of the preset content. For example, if couple images are searched for by the target object, the first view displays at least one group of couple images generated. The second view includes an entry for entering an image generation page. In a first implementation, an image generation operation triggered by the target object in the first view may be clicking/tapping any image displayed in the first view by the target object. The terminal device displays the image generation page in response to the image generation operation triggered by the target object in the first view.

In some embodiments, in an implementation, that the terminal device displays the image generation page in response to the image generation operation triggered by the target object in the first view in S106 may be specifically:

S1061: Display an image display page in response to a target operation of the target object on any target image in the at least one group of images in the first view, where the image display page includes the target image, the target information for generating the target image, and a third view, and the third view includes an entry for entering the image generation page.

S1062: Display the image generation page in response to an image generation operation triggered by the target object in the third view, where the target information for generating the target image is displayed in the text box of the image generation page.

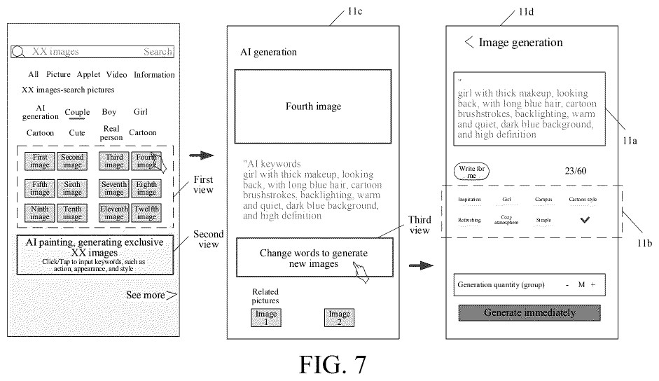

For example, FIG. 7 is a schematic diagram showing a process of displaying an image generation page according to an embodiment of this application. As shown in FIG. 7, the target object may click/tap any target image in at least one group of images in the first view. For example, the target object click/tap a fourth image. In response to the operation, the terminal device displays an image display page 11c shown in FIG. 7. The image display page 11c includes the fourth image, the target information for generating the fourth image, and a third view. As shown in FIG. 7, the target information for generating the fourth image is “girl with thick makeup, looking back, with long blue hair, cartoon brushstrokes, backlighting, warm and quiet, dark blue background, and high definition.” The third view includes an entry for entering the image generation page. The third view displays indication information, and the indication information is “change words to generate new images.” Next, if the target object clicks/taps the entry, in the third view, for entering the image generation page, for example, as shown in FIG. 7, the terminal device displays an image generation page 11d shown in FIG. 7 in response to an image generation operation triggered by the target object in the third view, the target information for generating the fourth image is displayed in a text box of the image generation page.

In some embodiments, in another implementation, that the terminal device displays the image generation page in response to the image generation operation triggered by the target object in the first view in S106 may be specifically:

S1061′: Display the image generation page in response to an image generation operation triggered by the target object in the second view.

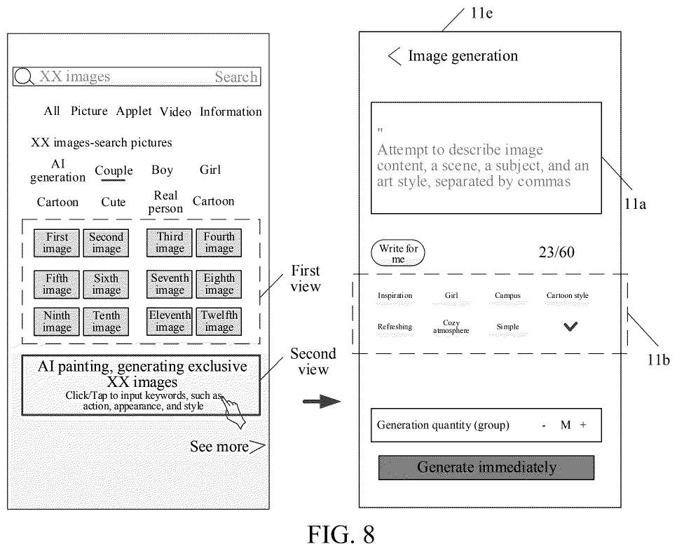

FIG. 8 is a schematic diagram showing a process of displaying an image generation page according to an embodiment of this application. As shown in FIG. 8, in the search result page shown in FIG. 6, the second view includes the entry for entering the image generation page. The target object may click/tap the second view. In this case, the terminal device displays an image generation page 11e shown in FIG. 8 in response to an image generation operation triggered by the target object in the second view.

In the foregoing two manners, the target object may customize an inputted text or modify the text, or input a text based on the recommended tag, to generate the images having pairwise relationships.

In some embodiments, in an implementation, the image generation page may further include an image generation type switching view. Image generation types include generation of a single image and generation of images having a pairwise relationship. The displaying the image generation page in S1061 and S1061′ may be specifically:

S11: Display an image generation page of a first type in response to an operation of selecting the generation of images having a pairwise relationship by the target object, where the image generation request further carries first indication information, and the first indication information is configured for indicating to generate images having a pairwise relationship of a first type or images having a pairwise relationship of a second type.

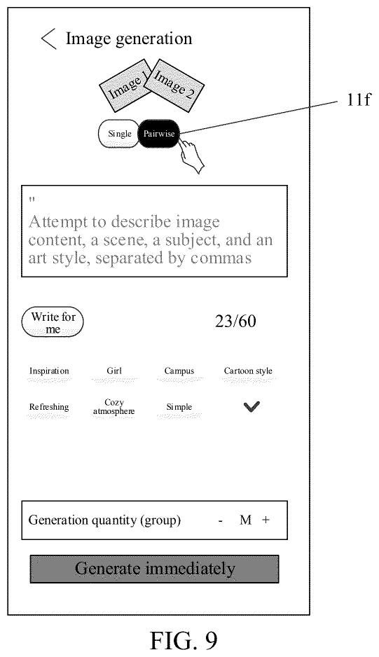

Specifically, the images having the pairwise relationship of the first type are, for example, couple images, the images having the pairwise relationship of the second type are, for example, bestie images, and the images having the pairwise relationship of the first type and the images having the pairwise relationship of the second type may alternatively be of other types of pairwise relationships. This is not limited in the embodiments of this application. FIG. 9 is a schematic diagram showing an image generation page according to an embodiment of this application. As shown in FIG. 9, based on the foregoing image generation page, this image generation page may further include an image generation type switching view 11f. Image generation types include generation of a single image (shown as “single” in FIG. 9) and generation of images having a pairwise relationship (shown as “pairwise” in FIG. 9). When the target object clicks/taps to switch to “pairwise,” the terminal device displays an image generation page of a first type in response to an operation of selecting the generation of images having a pairwise relationship by the target object. The image generation page of the first type is, for example, the image generation page shown in FIG. 9, where a generation quantity is displayed as group. Correspondingly, the image generation request further carries first indication information, and the first indication information is configured for indicating the server to generate images having a pairwise relationship of a first type or images having a pairwise relationship of a second type.

In another implementation, the method according to this embodiment may further include:

S21: Display an image generation page of a second type in response to an operation of selecting the generation of a single image by the target object, where the image generation request further carries second indication information, and the second indication information is configured for indicating to generate a single image.

S22: Receive N images transmitted by the server, where N is a positive integer.

S23: Display the N images.

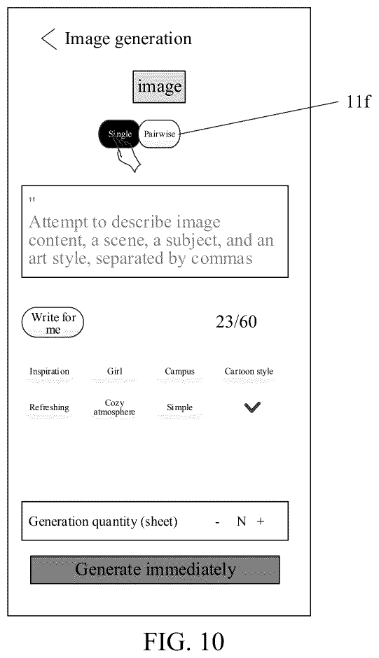

FIG. 10 is a schematic diagram showing an image generation page according to an embodiment of this application. As shown in FIG. 10, based on the foregoing image generation page, this image generation page may further include an image generation type switching view 11f. Image generation types include generation of a single image (shown as “single” in FIG. 10) and generation of images having a pairwise relationship (shown as “pairwise” in FIG. 10). When the target object clicks/taps to switch to “single,” the terminal device displays an image generation page of a second type in response to an operation of selecting the generation of a single image by the target object. The image generation page of the second type is, for example, the image generation page shown in FIG. 10, where a generation quantity is displayed as sheet. Correspondingly, the image generation request further carries second indication information, and the second indication information is configured for indicating the server to generate a single image. After generating N images based on the target information, the server transmits the N images to the terminal device, and the terminal device displays the N images.

In some embodiments, in an implementation, the image generation page further includes an image upload entry, the target information further includes a target image, and the target image is an image uploaded by the target object through the image upload entry. Before S102, the method according to this embodiment may further include:

S107: The terminal device receives the target image uploaded by the target object through the image upload entry.

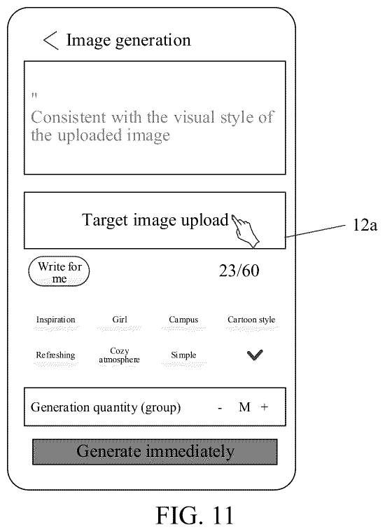

Specifically, the image generation page in this embodiment further includes an image upload entry. FIG. 11 is a schematic diagram showing an image generation page according to an embodiment of this application. As shown in FIG. 11, based on the foregoing image generation page, the image generation page in this embodiment may further include an image upload entry 12a. The target object may upload a target image through the image upload entry 12a. The uploaded target image may be an image photographed by the target object or an image downloaded from a network. Before or after uploading the target image, the target object may input a text set into a text box, for example, input “consistent with the visual style of the uploaded image” shown in FIG. 11. In some embodiments, another text may be inputted into the text box, and a recommended tag may be further selected.

In an embodiment, each group of the M groups of images includes the target image and a first image, the first image and the target image have a pairwise relationship in terms of the preset content, and the first image is generated by the server based on the text set, the target image, and the pre-trained image generation model.

In another embodiment, when the target information further includes a target image, the method according to this embodiment may further include:

S108: The terminal device receives M first images transmitted by the server, where the first image and the target image have a pairwise relationship in terms of the preset content, and the first image is generated by the server based on the text set, the target image, and the image generation model.

S109: The terminal device displays the M first images.

Alternatively, S109 may be: Respectively form a group of images by using the target image and each first image, to obtain the M groups of images, and display the M groups of images.

Correspondingly, the server generates the M groups of images based on the text set, the target image, and the pre-trained image generation model. Each group of the M groups of images includes two images that have a pairwise relationship in terms of the preset content. In this embodiment, the terminal device obtains the target information for performing image generation, the target information including the text set and the uploaded target image. In response to the image generation operation on the target information, the terminal device transmits the image generation request to the server, the image generation request carrying the target information. The server generates the M groups of images based on the target information and the pre-trained image generation model, each group of images including two images that have a pairwise relationship in terms of the preset content. The terminal device receives and displays the M groups of images transmitted by the server, to generate the images having pairwise relationships based on the inputted text set and the uploaded target image, thereby satisfying a requirement for generating personalized avatars having pairwise relationships.

In S103 above, the terminal device receives the M groups of images transmitted by the server. Each group of the M groups of images includes two images that have a pairwise relationship in terms of the preset content. The preset content may be, for example, style and subject content perception, or may be other content. This is not limited in the embodiments.

For example, an example in which M is equal to 1 is used. The obtained text set is, for example, “couple avatars wearing pink tops and pinching their faces.” Based on the text set, the server generates avatars having a pairwise relationship of a male and a female who wear pink clothes and pinch faces of each other. In this case, the couple avatars are two same images. In some embodiments, if the recommended tag selected by the target object is, for example, campus, the terminal device automatically fills in the displayed text box with a text conforming to a style of the campus, and finally matches the clothes, age, and the campus in generated images having a pairwise relationship. In some embodiments, if the recommended tag selected by the target object is, for example, cartoon, the terminal device automatically fills in the displayed text box with cartoon-related text information, and the server cartoonizes entire images while generating the images, and adds elements of Chinese and Japanese comic styles to the generated images. The finally generated images having a pairwise relationship have a typical cartoon style. In some embodiments, the recommended tag selected by the target object is, for example, art. When generating images, the server refers to styles of well-known paintings, and refers to typical styles and colors in the corresponding paintings, for final application and embodiment in the generated images having a pairwise relationship, so that the finally generated images having a pairwise relationship have styles of famous works and painters in terms of color matching, line direction, background elements, and the like, to finally form images having a pairwise relationship with styles of well-known paintings.

According to the image generation method provided in this embodiment, the terminal device obtains the target information for performing image generation, the target information including the text set. In response to the image generation operation on the target information, the terminal device transmits the image generation request to the server, the image generation request carrying the target information. The server generates the M groups of images based on the target information and the pre-trained image generation model, each group of images including two images that have a pairwise relationship in terms of the preset content. The terminal device receives and displays the M groups of images transmitted by the server, to generate the images having pairwise relationships based on the inputted text set, thereby satisfying a requirement for generating personalized avatars having pairwise relationships.

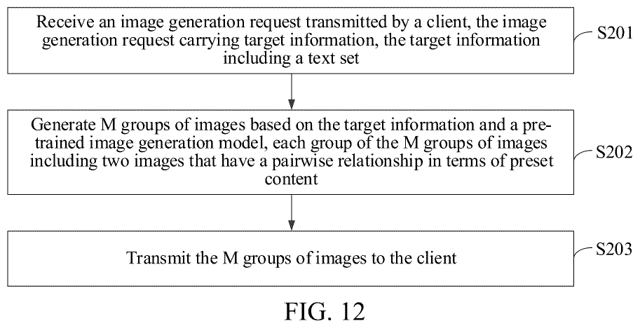

FIG. 12 is a flowchart of an image generation method according to an embodiment of this application. The method may be performed by an image generation apparatus, and the image generation apparatus may be implemented in a software and/or hardware manner. The image generation apparatus may be a server. As shown in FIG. 12, the method according to this embodiment of this application includes the following operations.

S201: A server receives an image generation request transmitted by a terminal device, the image generation request carrying target information, the target information including a text set.

S202: The server generates M groups of images based on the target information and a pre-trained image generation model, each group of the M groups of images including two images that have a pairwise relationship in terms of preset content.

S203: The server transmits the M groups of images to the terminal device.

Specifically, the image generation model may be pre-obtained through training based on samples. An input of the model is a text set, and an output of the model is an image generated based on the text set. Alternatively, an input of the model is a text set and an image, and an output of the model is an image generated based on the text set and the inputted image. Each group of the M groups of images includes two images that have a pairwise relationship in terms of the preset content. The preset content may be, for example, style and subject content perception, or may be other content. This is not limited in the embodiments.

In some embodiments, the image generation request may further carry first indication information. The first indication information is configured for indicating to generate images having a pairwise relationship of a first type or generate images having a pairwise relationship of a second type. The having the pairwise relationship of the first type are, for example, couple images, the images having the pairwise relationship of the second type are, for example, bestie images, and the images having the pairwise relationship of the first type and the images having the pairwise relationship of the second type may alternatively be of other types of pairwise relationships. This is not limited in the embodiments of this application. S202 may be specifically:

S2021: Generate the M groups of images based on the target information, the image generation model, and the first indication information.

In some embodiments, M is equal to 1, and S2021 may be specifically:

S31: Determine, based on the text set and the first indication information, a common element and a difference element for generating images having a pairwise relationship, where the elements are configured for describing the to-be-generated images.

Specifically, if the first indication information indicates to generate the images having the pairwise relationship of the first type (for example, couple images), a corresponding difference element may be gender, that is, male and female, and may further include another element. This is not limited in the embodiments. The common element may be determined based on a keyword in each text in the text set. For example, the text set is “student age, gold hair, star shining decoration, long hair, cartoon brushstrokes, relaxation, mystery, dark background, and high definition.” It may be determined that common elements include: student age, hair-gold long hair, star shining decoration, cartoon brushstrokes, relaxation, mystery, dark background, and high definition.

The elements are defined to describe the to-be-generated images. There may be a plurality of elements for describing an image. For example, an expression, a head attribute, a posture, an accessory, a background, a style, a lens, a picture, and the like are all groups of elements. For each group of elements, there are specific elements. For example, expressions may include smiling, crying, angry, laughing, sad, and the like; and head attributes may include glasses, a hairstyle, a color, and the like. An element pool may be preset, and the element pool includes a plurality of element groups and specific elements in each element group.

S32: Select, from a pre-stored element pool, elements respectively matching the common element and the difference element, and form a first text and a second text by using the selected elements, where the first text and the second text have a common element and a difference element.

Specifically, the example is stilled used in which the text set is “student age, gold hair, star shining decoration, long hair, cartoon brushstrokes, relaxation, mystery, dark background, and high definition.” Common elements of the determined text set include: student age, hair-gold long hair, star shining decoration, cartoon brushstrokes, relaxation, mystery, dark background, and high definition. The difference element includes male and female. The selecting, from the pre-stored element pool, the elements respectively matching the common element and the difference element may be specifically selecting, from the pre-stored element pool, elements respectively matching “student age, hair-gold long hair, star shining decoration, cartoon brushstrokes, relaxation, mystery, dark background, and high definition” and selecting elements matching male and female. The first text is formed by using the selected elements, and may be, for example, “lens with high definition, picture with dark background and mystery, head attribute being gold long hair, star shining decoration, style being cartoon brushstrokes, posture being student age, and male,” and may be, for example, “lens high definition, image dark-colored background with mystery, head attribute is gold long hair, star shining decoration, style is cartoon brushstrokes, and posture is student age and male.” The second text is formed by using the selected elements, and may be, for example, “lens with high definition, picture with dark background and mystery, head attribute being gold long hair, star shining decoration, style being cartoon brushstrokes, posture being student age, and female.”

S33: Input the first text and the second text into the image generation model, to output a first image and a second image, where the first image and the second image have a pairwise relationship in terms of the preset content.

Specifically, the first text and the second text are inputted into the image generation model. The image generation model may generate the first image based on the first text, and then generate the second image based on the second text. For a same text, the image generation model generates different images under different random seeds. In this way, a large quantity of random generation can be ensured. To be specific, when M is greater than 1, the image generation model repeatedly performs image generation for a plurality of times based on the inputted first text and second text, to generate the M groups of images.

Further, due to randomicity of the image generation model, the image generation model generates different images under different random seeds (also referred to as attention weights). For example, to make two images in a group of images as similar as possible to improve a degree of matching between the two images in the group of images, in an implementation, the inputting the first text and the second text into the image generation model, to output the first image and the second image in S33 may be specifically:

outputting the first image and the second image by using the first text, the second text, and indication information as an input of the image generation model, where the indication information is configured for indicating the image generation model that a difference between a first attention weight used when the first image is generated based on the first text and a second attention weight used when the second image is generated based on the second text is less than a preset threshold. The preset threshold may be 0. Therefore, the first attention weight is the same as the second attention weight. In this way, it can be ensured that the degree of matching between the two images in the group of images is high.

In some embodiments, M is greater than 1, the target information further includes M, and the text set includes a plurality of texts. The generating M groups of images based on the target information, the image generation model, and the first indication information in S2021 may be specifically:

S31′: Determine, based on the text set and the first indication information, a common element and a difference element for generating images having a pairwise relationship, where the elements are configured for describing the to-be-generated images.

Specifically, the first indication information is configured for indicating to generate images having a pairwise relationship of a first type or images having a pairwise relationship of a second type, and the determining the common element and the difference element for generating the images having a pairwise relationship is the same as the detailed process in S31. Details are not described herein again.

S32′: Select, from a pre-stored element pool, elements respectively matching the common element and the difference element, and form a first text and a second text by using the selected elements, where the first text and the second text have a common element and a difference element.

Specifically, a detailed process of S32′ is the same as the detailed process of S32. Details are not described herein again.

S33′: Input the first text, the second text, and M into the image generation model, where M is configured for indicating the image generation model to perform M times of image generation and output the M groups of images.

Specifically, the first text, the second text, and M are inputted into the image generation model. It can be known based on M that the image generation model needs to perform M times of image generation. Each image generation process is: inputting the first text and the second text into the image generation model, to output a first image and a second image, where the first image and the second image have a pairwise relationship in terms of the preset content. Specifically, the first image and the second image may be outputted by using the first text, the second text, and indication information as an input of the image generation model, where the indication information is configured for indicating the image generation model that a difference between a first attention weight used when the first image is generated based on the first text and a second attention weight used when the second image is generated based on the second text is less than a preset threshold. After the M times of image generation, the M groups of images are obtained and outputted.

In some embodiments, the target information further includes a target image, and S2021 may be specifically:
generating the M groups of images based on the text set, the target image, the image generation model, and the first indication information.

Specifically, in an implementation, the generating the M groups of images based on the text set, the target image, the image generation model, and the first indication information may specifically include:

S41: Extract feature elements of the target image.

In some embodiments, the extracting the feature elements of the target image in S41 may be specifically:
performing noise processing on the target image, and extracting the feature elements of the target image obtained through the noise processing. Denoising processing is performed by using the image generation model. Higher noise intensity indicates higher quality and creativity of a generated image, but a lower similarity with the inputted target image. Otherwise, lower noise intensity indicates lower quality and creativity of a generated image, but a higher similarity with the inputted target image.

S42: Determine, based on the feature elements of the target image and the first indication information, a difference element corresponding to some of the feature elements.

Specifically, the first indication information is configured for indicating to generate images having a pairwise relationship of a first type or images having a pairwise relationship of a second type. For example, the first indication information is configured for indicating to generate couple images. If the target image is a male image, the difference element corresponding to some of the feature elements is female.

S43: Obtain a target element of the text set.

S44: Select, from a pre-stored element pool, elements respectively matching the feature elements, the target element, and the difference element, and form a third text by using the selected elements.

Specifically, the first indication information is configured for indicating to generate couple images. If the target image is a male image, the difference element corresponding to some of the feature elements is female, and the third text includes a female element.

S45: Input the third text and M into the image generation model, where M is configured for indicating the image generation model to perform M times of image generation, output M images, and obtain the M groups of images based on the target image and the M images.

Specifically, the third text and M are inputted into the image generation model. It can be known based on M that the image generation model needs to perform M times of image generation. Each image generation process is: inputting the third text as an input of the image generation model, to output an image, where the image and the target image are images having a pairwise relationship; and performing M times of image generation, to obtain M images, where each image and the target image form a group of images having a pairwise relationship, to finally obtain the M groups of images.

According to the method in this embodiment, for example, the uploaded target image is a photograph of a female in a seaside. The image generation model extracts feature elements such as a seaside and scenery in the target image to generate an image of a male in the seaside, where a style of the image is similar to that of the uploaded female image.

In this embodiment of this application, in some embodiments, the pre-trained image generation model may be an image generation model (for example, a stable diffusion general model) based on a diffusion model, and the pre-trained image generation model may further include a plurality of Lora models. The Lora model is a lightweight model based on the stable diffusion general model that is fine-tuned on a specific style dataset.

In this embodiment of this application, the image generation model may be controlled, by using style elements included in the inputted text, to generate images of different styles, or a plurality of image generation models (for example, Lora models) for generating images of different styles may be pre-stored, to improve diversity of styles of generated images. The styles may include, for example, cartoon, Sanskan, brief, campus, and Chinese style.

According to the image generation method provided in this embodiment, the server receives the image generation request transmitted by the client, the image generation request carrying the target information, the target information including the text set; generates the M groups of images based on the target information and the pre-trained image generation model, each group of the M groups of images including two images that have a pairwise relationship in terms of the preset content; and transmits the M groups of images to the client. Therefore, images having pairwise relationships can be generated based on the inputted text set, thereby meeting a requirement for generating personalized avatars having pairwise relationships.

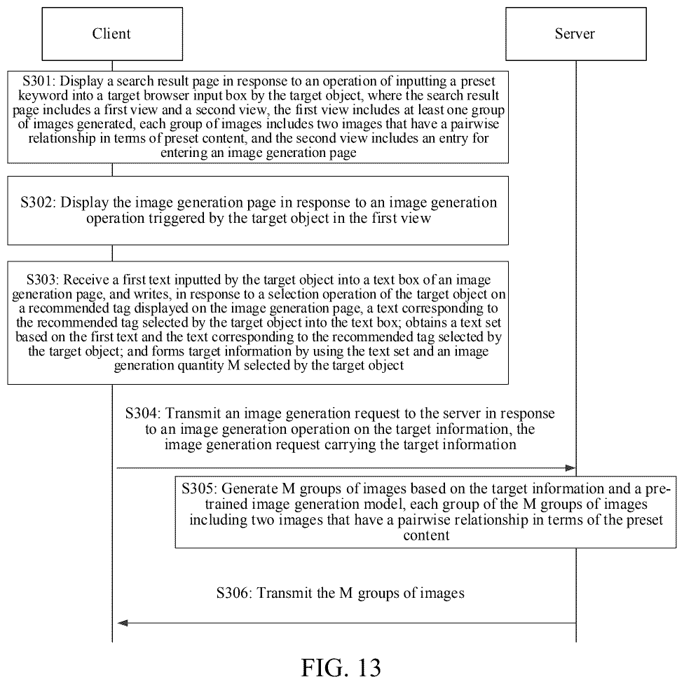

The following describes the image generation method provided in the embodiments of this application in detail by using a specific embodiment. An interaction processing process of the image generation method provided in the embodiments of this application is specifically described with reference to FIG. 13.

FIG. 13 is an interaction flowchart of an image generation method according to an embodiment of this application. As shown in FIG. 13, this embodiment is described by using an example in which images having a pairwise relationship are generated based on an inputted text set. The method may include the following operations:

S301: A client displays a search result page in response to an operation of inputting a preset keyword into a target browser input box by a target object, where the search result page includes a first view and a second view, the first view includes at least one group of images generated, each group of images includes two images that have a pairwise relationship in terms of preset content, and the second view includes an entry for entering an image generation page.

S302: The client displays the image generation page in response to an image generation operation triggered by the target object in the first view.

Specifically, in an embodiment, for the search result page, refer to FIG. 6. In some embodiments, in an implementation, the displaying the image generation page in response to the image generation operation triggered by the target object in the first view in S302 may be specifically:

S3021: The client displays an image display page in response to a target operation of the target object on any target image in the at least one group of images in the first view, where the image display page includes the target image, the target information for generating the target image, and a third view, and the third view includes an entry for entering the image generation page.

S3022: The client displays the image generation page in response to an image generation operation triggered by the target object in the third view, where the target information for generating the target image is displayed in the text box of the image generation page.

In some embodiments, in another implementation, the displaying the image generation page in response to the image generation operation triggered by the target object in the first view in S302 may be specifically:

S3021′: The client displays the image generation page in response to an image generation operation triggered by the target object in the second view.

In the foregoing two manners, the target object may customize an inputted text or modify the text, or input a text based on the recommended tag, to generate the images having pairwise relationships.

In some embodiments, in an implementation, the image generation page may further include an image generation type switching view. Image generation types include generation of a single image and generation of images having a pairwise relationship. The displaying the image generation page in S3022 and S3021′ may be specifically:

S51: The client displays an image generation page of a first type in response to an operation of selecting the generation of images having a pairwise relationship by the target object, where the image generation request further carries first indication information, and the first indication information is configured for indicating to generate images having a pairwise relationship of a first type or images having a pairwise relationship of a second type.

In another implementation, the method according to this embodiment may further include:

S61: The client displays an image generation page of a second type in response to an operation of selecting the generation of a single image by the target object, where the image generation request further carries second indication information, and the second indication information is configured for indicating to generate a single image.

S62: The client receives N images transmitted by the server, where N is a positive integer.

S63: The client displays the N images.

S303: The client receives a first text inputted by the target object into a text box of the image generation page, and writes, in response to a selection operation of the target object on a recommended tag displayed on the image generation page, a text corresponding to the recommended tag selected by the target object into the text box; obtains a text set based on the first text and the text corresponding to the recommended tag selected by the target object; and forms target information by using the text set and an image generation quantity M selected by the target object.

In some embodiments, S303 may alternatively be receiving the text set inputted by the target object into a text box of an image generation page. Alternatively, in response to a selection operation of the target object on a recommended tag displayed on an image generation page, a text corresponding to the recommended tag selected by the target object is written into a text box; and the text set is obtained based on the text corresponding to the recommended tag selected by the target object.

S304: The client transmits an image generation request to a server in response to an image generation operation on the target information, the image generation request carrying the target information.

S305: The server generates M groups of images based on the target information

and a pre-trained image generation model, each group of the M groups of images including two images that have a pairwise relationship in terms of the preset content.

S306: The server transmits the M groups of images to the client.

Each group of the M groups of images includes two images that have a pairwise relationship in terms of the preset content. The preset content may be, for example, style and subject content perception, or may be other content. This is not limited in the embodiments.

After receiving the M groups of images, the client displays the M groups of images.

Specifically, the server generates the M groups of images based on the target information and the pre-trained image generation model. For a specific implementation, refer to the descriptions in the embodiments shown in FIG. 11. Details are not described herein again.

In some embodiments, in another embodiment, S303 may be specifically: The client receives a first text inputted by the target object into a text box of an image generation page, and writes, in response to a selection operation of the target object on a recommended tag displayed on the image generation page, a text corresponding to the recommended tag selected by the target object into the text box; obtains the text set based on the first text and the text corresponding to the recommended tag selected by the target object; and forms, in response to a target image uploaded by the target object through an image upload entry, the target information by using the text set, the target image, and an image generation quantity M selected by the target object.

Correspondingly, for the generating, by the server, the M groups of images based on the target information and the pre-trained image generation model in S305, refer to the descriptions in S41 to S45. Details are not described herein again.

In this embodiment, correspondingly, S306 may be specifically: The server transmits M first images to the client, where the first image and the target image have a pairwise relationship in terms of the preset content, and the first image is generated by the server based on the text set, the target image, and the image generation model.

After receiving the M first images, the client may directly display the M first images, or may respectively form a group of images by using the target image and each first image, to obtain the M groups of images, and display the M groups of images.

In the embodiments of this application, unless otherwise specified, the sequence of the operations is not limited. For the same or corresponding descriptions on the client side, refer to the descriptions in the embodiments shown in FIG. 4. For the same or corresponding descriptions on the server side, refer to the descriptions in the embodiments shown in FIG. 12. Details are not described herein again.

In an embodiment, in the method according to this embodiment, style conversion may be further performed on the target image based on the target image uploaded by the target object. For example, a real-person image is cartoonized. A corresponding specific implementation may be: The terminal device obtains the target image in response to an operation of uploading the target image by the target object; the terminal device obtains the text set in response to an operation of inputting a text by the target object, where the target image and the text set form the target information; and the terminal device transmits the image generation request to the server in response to the image generation operation on the target information, where the image generation request carries the target information and indication information indicating generation of a single image. The text set includes, for example, a cartoon style. The server generates an image of the cartoon style based on the target information and the indication information. The image is an image obtained by cartoonizing the target image.

In another embodiment, in the method according to this embodiment, gender conversion may be further performed based on image person gender recognition. For example, an uploaded female behavior image may be correspondingly converted into a corresponding male behavior image.

In another embodiment, in the method according to this embodiment, a face area is extracted from the target image uploaded by the target object, and the face is replaced as a whole and integrated with clothes of different countries to achieve a change of clothes. For example, the target object uploads an ID photo wearing a suit through the image upload entry, and the server may extract a face and integrate the face with representative clothes into an image.

In another embodiment, in the method according to this embodiment, based on the target image uploaded by the target object and the inputted text set, a text in the text set or an image indicated by a text in the text set is superimposed on the target image, to form a new image. For example, an original element of the target image is changed by adding accessories such as wings and headwear to the uploaded target image, or n expression (for example, smiling and crying) of a person in the target image may be modified and/or a text is added to form an expression image.

According to the image generation method provided in this embodiment, images having pairwise relationships can be generated based on the inputted text set, thereby meeting a requirement for generating personalized avatars having pairwise relationships. Further, images having pairwise relationships can be generated based on the inputted text set and the uploaded target image, thereby satisfying the requirement for generating personalized avatars having pairwise relationships.

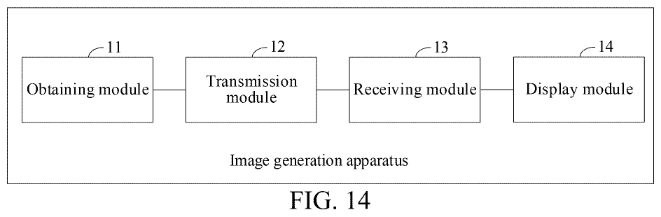

FIG. 14 is a schematic structural diagram of an image generation apparatus according to an embodiment of this application. As shown in FIG. 14, the apparatus may include: an obtaining module 11, a transmission module 12, a receiving module 13, and a display module 14.

The obtaining module 11 is configured to obtain target information for performing image generation, the target information including a text set.

The transmission module 12 is configured to transmit an image generation request to a server in response to an image generation operation on the target information, the image generation request carrying the target information.

The receiving module 13 is configured to receive M groups of images transmitted by the server, each group of the M groups of images including two images that have a pairwise relationship in terms of preset content, the M groups of images being generated by the server based on the target information and a pre-trained image generation model, and M being a positive integer.

The display module 14 is configured to display the M groups of images.

In an embodiment, the obtaining module 11 is configured to:
receive the text set inputted by a target object in a text box of an image generation page; or
receive a first text inputted by a target object in a text box of an image generation page;
write, in response to a selection operation of a target object on a recommended tag displayed on an image generation page, a text corresponding to the recommended tag selected by the target object into a text box; and
obtain the text set based on the first text and the second text corresponding to the recommended tag selected by the target object; or
write, in response to a selection operation of a target object on a recommended tag displayed on an image generation page, a text corresponding to the recommended tag selected by the target object into a text box; and
obtain the text set based on the text corresponding to the recommended tag selected by the target object.

In an embodiment, the target information further includes M, M is configured for indicating an image generation quantity, and the obtaining module 11 is further configured to:
combine the text set and M to form the target information.

In an embodiment, the display module 14 is further configured to:
display, before the obtaining module 11 obtains the target information for performing image generation, a search result page in response to an operation of inputting a preset keyword into a target browser input box by the target object, where the search result page includes a first view and a second view, the first view includes at least one group of images generated, each group of images includes two images that have a pairwise relationship in terms of the preset content, and the second view includes an entry for entering an image generation page; and
display the image generation page in response to an image generation operation triggered by the target object in the first view; or
display the image generation page in response to an image generation operation triggered by the target object in the second view.

In an embodiment, the display module 14 is specifically configured to:
display an image display page in response to a target operation of the target object on any target image in the at least one group of images in the first view, where the image display page includes the target image, the target information for generating the target image, and a third view, and the third view includes an entry for entering the image generation page; and
display the image generation page in response to an image generation operation triggered by the target object in the third view, where the target information for generating the target image is displayed in the text box of the image generation page.

In an embodiment, the image generation page includes an image generation type switching view, image generation types include generation of a single image and generation of images having a pairwise relationship, and the display module 14 is specifically configured to:
display an image generation page of a first type in response to an operation of selecting the generation of images having a pairwise relationship by the target object, where the image generation request further carries first indication information, and the first indication information is configured for indicating to generate images having a pairwise relationship of a first type or images having a pairwise relationship of a second type.

In an embodiment, the display module 14 is further configured to:
display an image generation page of a second type in response to an operation of selecting the generation of a single image by the target object, where the image generation request further carries second indication information, and the second indication information is configured for indicating to generate a single image;
the receiving module 13 is further configured to receive N images transmitted by the server, where N is a positive integer; and
the display module 14 is further configured to display the N images.

In an embodiment, the image generation page further includes an image upload entry, the target information further includes a target image, and receiving module 13 is further configured to: receive the target image uploaded by the target object through the image upload entry.

In an embodiment, each group of the M groups of images includes the target image and a first image, the first image and the target image have a pairwise relationship in terms of the preset content, and the first image is generated by the server based on the text set, the target image, and the image generation model.

In an embodiment, the receiving module 13 is configured to receive M first images transmitted by the server, where the first image and the target image have a pairwise relationship in terms of the preset content, and the first image is generated by the server based on the text set, the target image, and the image generation model; and
the display module 14 is configured to display the M first images; or
respectively form a group of images by using the target image and each first image, to obtain the M groups of images; and
display the M groups of images.

After the uploaded target image is received, the target image may alternatively be processed with reference to the text set such as a style and a scenario, to generate the processed target image. In addition, the first image is generated based on the text set and the target image. Alternatively, the first image is generated based on the processed target image, the first image and the processed target image form a group of images, and the two images may be couple images that meet descriptions of the text set. Specifically, an uploaded real-person female image may be received, and the female image is processed with reference to the text set, for example, processed into a cartoon style, a style of a movie or television work, or a background of a campus scene. A male image with a corresponding style or background is then generated based on the real-person female image with reference to the text set, or a corresponding male image is directly generated through gender conversion based on the processed female image, to form couple avatars.

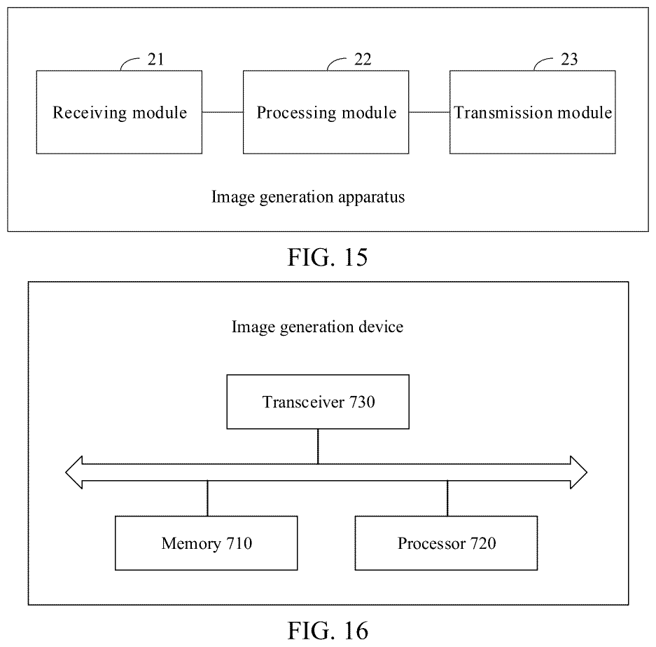

FIG. 15 is a schematic structural diagram of an image generation apparatus according to an embodiment of this application. As shown in FIG. 15, the apparatus may include: a receiving module 21, a processing module 22, and a transmission module 23.

The receiving module 21 is configured to receive an image generation request transmitted by a client, the image generation request carrying target information, the target information including a text set.

The processing module 22 is configured to generate M groups of images based on the target information and a pre-trained image generation model, each group of the M groups of images including two images that have a pairwise relationship in terms of preset content.

The transmission module 23 is configured to transmit the M groups of images to the client.

In an embodiment, the image generation request further carries first indication information, and the first indication information is configured for indicating to generate images having a pairwise relationship of a first type or images having a pairwise relationship of a second type; and
the processing module 22 is configured to generate the M groups of images based on the target information, the image generation model, and the first indication information.

In an embodiment, M is equal to 1, the text set includes a plurality of texts, and the processing module 22 is configured to:
determine, based on the text set and the first indication information, a common element and a difference element for generating images having a pairwise relationship, where the elements are configured for describing the to-be-generated images;
select, from a pre-stored element pool, elements respectively matching the common element and the difference element, and form a first text and a second text by using the selected elements, where the first text and the second text have a common element and a difference element; and
input the first text and the second text into the image generation model, to output a first image and a second image, where the first image and the second image have a pairwise relationship in terms of the preset content.

In an embodiment, the processing module 22 is specifically configured to:
output the first image and the second image by using the first text, the second text, and indication information as an input of the image generation model, where the indication information is configured for indicating the image generation model that a difference between a first attention weight used when the first image is generated based on the first text and a second attention weight used when the second image is generated based on the second text is less than a preset threshold.

In an embodiment, M is greater than 1, the target information further includes M, the text set includes a plurality of texts, and the processing module 22 is specifically configured to:
determine, based on the text set and the first indication information, a common element and a difference element for generating images having a pairwise relationship, where the elements are configured for describing the to-be-generated images;
select, from a pre-stored element pool, elements respectively matching the common element and the difference element, and form a first text and a second text by using the selected elements, where the first text and the second text have a common element and a difference element; and
input the first text, the second text, and M into the image generation model, where M is configured for indicating the image generation model to perform M times of image generation and output the M groups of images.

In an embodiment, the target information further includes a target image, and the processing module 22 is configured to:
generate the M groups of images based on the text set, the target image, the image generation model, and the first indication information.

In an embodiment, the processing module 22 is specifically configured to:
extract feature elements of the target image;
determine, based on the feature elements of the target image and the first indication information, a difference element corresponding to some of the feature elements; obtain a target element of the text set;
select, from a pre-stored element pool, elements respectively matching the feature elements, the target element, and the difference element, and form a third text by using the selected elements; and
input the third text and M into the image generation model, where M is configured for indicating the image generation model to perform M times of image generation, output M images, and obtain the M groups of images based on the target image and the M images.

In an embodiment, the processing module 22 is specifically configured to:
perform noise processing on the target image, and extract the feature elements of the target image obtained through the noise processing.

The apparatus embodiments and the method embodiments may correspond to each other, and for similar descriptions, refer to the method embodiments. To avoid repetition, details are not described herein again. Specifically, the apparatus shown in FIG. 15 may perform method embodiments corresponding to an instant messaging client. In addition, the foregoing and other operations and/or functions of the modules in the apparatus shown in FIG. 15 are separately used to implement the method embodiments corresponding to the instant messaging client. For brevity, details are not described herein again.

The image generation apparatus according to the embodiments of this application is described above with reference to the accompanying drawings from the perspective of functional modules. The functional modules may be implemented in a form of hardware, or may be implemented in a form of software, or may be implemented in a combination of hardware and software modules. Specifically, operations of the method embodiments in the embodiments of this application may be completed by instructions in the form of hardware integrated logic circuits and/or software in the processor, and operations of the methods disclosed with reference to the embodiments of this application may be directly performed and completed by using a hardware decoding processor, or may be performed and completed by using a combination of hardware and software modules in the decoding processor. In some embodiments, the software module may be located in a mature storage medium in the art, such as a random access memory, a flash memory, a read-only memory, a programmable read-only memory, an electrically-erasable programmable memory, and a register. The storage medium is located in the memory. The processor reads information in the memory and completes the operations in the method embodiments in combination with hardware thereof.

FIG. 16 is a schematic block diagram of an image generation device according to an embodiment of this application. The image generation device may be a terminal device or a server.

As shown in FIG. 16, the image generation device may include:
a memory 710 and a processor 720, where the memory 710 is configured to store a computer program and transmit program code to the processor 720. In other words, the processor 720 may invoke and run the computer program from the memory 710 to implement the method in the embodiments of this application.

For example, the processor 720 may be configured to perform the foregoing method embodiments according to instructions in the computer program.

In some embodiments of this application, the processor 720 may include, but not limited to:
a general-purpose processor, a digital signal processor (DSP), an application-specific integrated circuit (ASIC), a field-programmable gate array (FPGA) or another programmable logic device, a discrete gate or transistor logic device, a discrete gate or a transistor logic device, a discrete hardware component, or the like.

In some embodiments of this application, the memory 710 includes, but not limited to:
a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through illustrative but not limited description, RAMs in many forms, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DRRAM), are available.

In some embodiments of this application, the computer program may be divided into one or more modules, and the one or more modules are stored in the memory 710 and executed by the processor 720 to complete the methods provided in the embodiments of this application. The one or more modules may be a series of computer program instruction sections that can implement specific functions, and the instruction sections are configured for describing an execution process of the computer program in the image generation device.

As shown in FIG. 16, the image generation device may further include:
a transceiver 730, where the transceiver 730 is connected to the processor 720 or the memory 710.

The processor 720 may control the transceiver 730 to communicate with another device, and specifically, may transmit information or data to another device or receive information or data transmitted by another device. The transceiver 730 may include a transmitter and a receiver. The transceiver 730 may further include an antenna, and a quantity of antennas may be one or more.

Various components in the image generation device are connected to each other through a bus system. In addition to a data bus, the bus system further includes a power bus, a control bus, and a status signal bus.

This application further provides a computer storage medium, having a computer program stored therein. The computer program, when executed by a computer, causes the computer to perform the methods according to the foregoing method embodiments. Alternatively, an embodiment of this application further provides a computer program product including instructions. The instructions, when executed by a computer, cause the computer to perform the methods according to the method embodiments.

When embodiments are implemented by using software, all or some of the embodiments may be implemented in a form of a computer program product. The computer program product includes one or more computer instructions. When the computer instructions are loaded and executed on a computer, all or some of the procedures or functions according to the embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium that a computer can access or a data storage device like a server or a data center that includes one or more integrated available media. The available medium may be a magnetic medium (for example, a floppy disk, a hard disk, or a magnetic tape), an optical medium (for example, a digital video disc (DVD)), a semiconductor medium (for example, a solid state drive (SSD)), or the like.

A person of ordinary skill in the art may be aware that, modules and algorithm operations in the examples described with reference to the embodiments disclosed in this specification may be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this application.

In the several embodiments provided in this application, the disclosed system, apparatus, and method may be implemented in other manners. For example, the foregoing described apparatus embodiments are merely exemplary. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or modules may be implemented in electronic, mechanical, or other forms.

The modules described as separate components may or may not be physically separated, and the components displayed as modules may or may not be physical modules, and may be located in one place or may be distributed over a plurality of network units. Some or all of the modules may be selected according to an actual requirement to implement the objectives of the solutions of the embodiments. For example, the functional modules in the embodiments of this application may be integrated into one processing module, or the functional modules may exist alone physically, or two or more modules may be integrated into one module.

The above descriptions are merely some implementations of this application, and are not intended to limit the protection scope of this application. Any variation or replacement readily figured out by a person skilled in the art within the technical scope disclosed in this application falls within the protection scope of this application. Therefore, the protection scope of this application shall be subject to the protection scope of the claims.

What is claimed is:

1. An image generation method comprising:
obtaining target information including a text set;
transmitting an image generation request to a server in response to an image generation operation on the target information, the image generation request carrying the target information;
receiving M groups of images transmitted by the server, each of the M groups of images including two images that have a pairwise relationship in terms of preset content, the M groups of images being generated by the server based on the target information and a pre-trained image generation model, and M being a positive integer; and
displaying the M groups of images.

2. The image generation method according to claim 1, wherein obtaining the target information includes:
receiving the text set inputted in a text box of an image generation page; or
receiving a first text inputted in the text box, writing, in response to a selection operation on a recommended tag displayed on the image generation page, a second text corresponding to the recommended tag into the text box, and obtaining the text set based on the first text and the second text; or
writing, in response to the selection operation on the recommended tag, a text corresponding to the recommended tag into the text box, and obtaining the text set based on the text corresponding to the recommended tag.

3. The image generation method according to claim 1, further comprising:
combining the text set and the number M to form the target information.

4. The image generation method according to claim 1, further comprising, before obtaining the target information:
displaying a search result page in response to an operation of inputting a preset keyword into a target browser input box, the search result page including a first view and a second view, the first view including at least one group of generated images, each of the at least one group of generated images including two images that have a pairwise relationship in terms of the preset content, and the second view including an entry for entering an image generation page; and
displaying the image generation page in response to an image generation operation in the first view or in the second view.

5. The image generation method according to claim 4, wherein displaying the image generation page in response to the image generation operation in the first view includes:
displaying an image display page in response to a target operation on a target image in the at least one group of generated images in the first view, the image display page including the target image, information for generating the target image, and a third view, and the third view including an entry for entering the image generation page; and
displaying the image generation page in response to an image generation operation in the third view, the information for generating the target image being displayed in a text box of the image generation page.

6. The image generation method according to claim 4, wherein:
the image generation page includes an image generation type switching view, image generation types including a first generation type for generating a single image and a second generation type for generating images having a pairwise relationship; and
displaying the image generation page includes:
displaying an image generation page of a specific type in response to an operation of selecting the second generation type, the image generation request further carrying indication information configured for indicating to generate images having a pairwise relationship of a first type or images having a pairwise relationship of a second type.

7. The image generation method according to claim 6,
wherein the image generation page of the specific type is an image generation page of a first type, and the indication information is first indication information;
the method further comprising:
displaying an image generation page of a second type in response to an operation of selecting the first generation type, the image generation request further carrying second indication information configured for indicating to generate a single image;
receiving N images transmitted by the server, N being a positive integer; and
displaying the N images.

8. The image generation method according to claim 1, further comprising:
receiving a target image uploaded through an image upload entry in an image generation page, the target information further including the target image.

9. The image generation method according to claim 8, wherein each of the M groups of images includes the target image and a generated image generated by the server based on the text set, the target image, and the image generation model, the generated image and the target image having a pairwise relationship in terms of the preset content.

10. The image generation method according to claim 8, further comprising:
receiving, from the server, M generated images generated by the server based on the text set, the target image, and the image generation model, each of the M generated images and the target image having a pairwise relationship in terms of the preset content; and
displaying the M generated images, or forming each of the M groups of images using the target image and one of the M generated images.

11. A non-transitory computer-readable storage medium storing a computer program that, when executed by a processor, causes a computer having the processor to perform the image generation method according to claim 1.

12. An image generation device comprising:
a processor; and
a memory storing a computer program that, when executed by the processor, causes the device to:
obtain target information including a text set;
transmit an image generation request to a server in response to an image generation operation on the target information, the image generation request carrying the target information;
receive M groups of images transmitted by the server, each of the M groups of images including two images that have a pairwise relationship in terms of preset content, the M groups of images being generated by the server based on the target information and a pre-trained image generation model, and M being a positive integer; and
display the M groups of images.

13. An image generation method comprising:
receiving an image generation request transmitted by a terminal device, the image generation request carrying target information including a text set;
generating M groups of images based on the target information and a pre-trained image generation model, each of the M groups of images including two images that have a pairwise relationship in terms of preset content; and
transmitting the M groups of images to the terminal device.

14. The image generation method according to claim 13, wherein:
the image generation request further carries indication information configured for indicating to generate images having a pairwise relationship of a first type or images having a pairwise relationship of a second type; and
generating the M groups of images includes:
generating the M groups of images based on the target information, the image generation model, and the indication information.

15. The image generation method according to claim 14, wherein:
M is equal to 1, and the text set includes a plurality of texts; and
generating the M groups of images based on the target information, the image generation model, and the indication information includes:
determining, based on the text set and the indication information, a common element and a difference element describing images to be generated;
selecting, from a pre-stored element pool, elements respectively matching the common element and the difference element, and forming a first text and a second text using the selected elements, the first text and the second text having the common element and the difference element; and
inputting the first text and the second text into the image generation model, to output a first image and a second image having a pairwise relationship in terms of the preset content.

16. The image generation method according to claim 15, wherein:
the indication information is first indication information; and
inputting the first text and the second text into the image generation model to output the first image and the second image includes:
outputting the first image and the second image using the first text, the second text, and second indication information as an input of the image generation model, the second indication information being configured for indicating that a difference between a first attention weight and a second attention weight is less than a preset threshold, the first attention weight being used in generating the first image based on the first text, and the second attention weight being used in generating the second image based on the second text.

17. The image generation method according to claim 14, wherein:
M is greater than 1, the target information further includes the number M, and the text set includes a plurality of texts; and
generating the M groups of images based on the target information, the image generation model, and the indication information includes:
determining, based on the text set and the first indication information, a common element and a difference element describing images to be generated;
selecting, from a pre-stored element pool, elements respectively matching the common element and the difference element, and forming a first text and a second text using the selected elements, the first text and the second text having the common element and the difference element; and
inputting the first text, the second text, and the number M into the image generation model, the number M being configured for indicating to perform M times of image generation and output the M groups of images.

18. The image generation method according to claim 14, wherein:
the target information further includes a target image; and
generating the M groups of images based on the target information, the image generation model, and the first indication information includes:
generating the M groups of images based on the text set, the target image, the image generation model, and the indication information.

19. The image generation method according to claim 18, wherein generating the M groups of images based on the text set, the target image, the image generation model, and the indication information includes:
extracting feature elements of the target image;
determining, based on the feature elements and the indication information, a difference element corresponding to one or more of the feature elements;
obtaining a target element of the text set;
selecting, from a pre-stored element pool, elements respectively matching the feature elements, the target element, and the difference element, and forming a text using the selected elements; and
inputting the formed text and the number M into the image generation model, the number M being configured for indicating to perform M times of image generation, outputting M images, and obtaining the M groups of images based on the target image and the M images.

20. The image generation method according to claim 19, wherein extracting the feature elements includes:
performing noise processing on the target image, and extracting the feature elements of the target image that has undergone the noise processing.
